(19) United States
(12) Patent Application Publication
(10) Pub. No.: US 2025/0377277 A1
(43) Pub. Date: Dec. 11, 2025

(54) UTILITY VEHICLE FOR COMPACTING HARVESTED MATERIAL

(71) Applicant: Deere & Company, Moline, IL (US)

(72) Inventors: Stefan Brocke, Mannheim (DE); Norbert Peter Fritz, Ilvesheim (DE)

(21) Appl. No.: 19/229,244

(22) Filed: Jun. 5, 2025

(30) Foreign Application Priority Data
Jun. 10, 2024 (EP) 24181037.3

(51) Int. Cl. G01N 9/00; A01F 25/16

(52) U.S. Cl. CPC G01N 9/00; A01F 25/16

(57) ABSTRACT

A utility vehicle for compacting a stored harvested material by driving over a surface of the harvested material includes a radar sensor configured for ascertaining a density of the stored harvested material by sending radar signals in a direction of the harvested material and receiving radar signals reflected on the harvested material. The radar sensor is arranged on a support device which is movably mounted on the utility vehicle and can be set between a transporting position for the radar sensor and a working position for the radar sensor which is lowered relative to the transporting position.

### CROSS-REFERENCE TO RELATED APPLICATIONS

This application claims priority to European Patent Application No. 24181037.3, filed Jun. 10, 2024, which is hereby incorporated by reference.

### TECHNICAL FIELD

The present disclosure relates generally to a utility vehicle for compacting harvested material.

### BACKGROUND

Silage, which is produced from cuttings, such as grass, corn, clover, alfalfa, broad beans, or grains by fermentation (lactic acid fermentation) is often used for animal feed. A sensor that works with radar waves is used to measure the density of the silage.

### SUMMARY

According to an aspect of the present disclosure, a utility vehicle for compacting a stored harvested material by driving over a surface of the harvested material includes a radar sensor configured for ascertaining a density of the stored harvested material by sending radar signals in a direction of the harvested material and receiving radar signals reflected on the harvested material. The radar sensor is arranged on a support device which is movably mounted on the utility vehicle and can be set between a transporting position for the radar sensor and a working position for the radar sensor which is lowered relative to the transporting position.

Other features and aspects will become apparent by consideration of the detailed description, claims, and accompanying drawings.

### BRIEF DESCRIPTION OF THE DRAWINGS

The disclosure is explained in greater detail below with reference to the appended drawings. Component parts of equivalent or comparable function are identified by the same reference signs in this case. In the drawings:

FIG. 1 shows an illustration in the manner of a block diagram of the system according to the disclosure, and

FIG. 2 shows an illustration in the manner of a block diagram of details of the method according to the disclosure, and

FIG. 3 shows a schematic illustration of the generation of reference data, and

FIG. 4a shows a schematic plan view of a utility vehicle and a harvested material to be compacted, and

FIG. 4b shows a side view of the utility vehicle and the harvested material to be compacted according to the arrow direction IV-B in FIG. 4a, and

FIG. 5 shows a schematic side view of a sensor device with a radar sensor, and

FIG. 6 shows an enlarged schematic view of the detail VI in FIG. 1, and

FIG. 7a shows a side view of a utility vehicle with the sensor device according to FIG. 6 in a working position, and

FIG. 7b shows the side view of the utility vehicle according to FIG. 7a with the sensor device in a transporting position.

Like reference numerals are used to indicate like elements throughout the several figures.

### DETAILED DESCRIPTION

It is known from DE 10 2020 110 297 A1 to detect the density of silage when the silage is compacted in a silo. For this, a sensor that works with radar waves is used, which can be fixed on the front of a compaction vehicle.

The object of the present disclosure is to further improve a radar-based ascertainment of a silage density.

This object is achieved by a utility vehicle having the features of one or more embodiments disclosed herein.

Further advantageous embodiments of the disclosure can be found in one or more embodiments disclosed herein.

Proposed in one or more embodiments disclosed herein is a utility vehicle for compacting a stored harvested material by driving over a surface of the harvested material or biomaterial. The utility vehicle is equipped with a radar sensor for ascertaining a density of the stored harvested material. For the purpose of ascertaining the density, the radar sensor sends radar signals in the direction of the harvested material and receives radar signals that are reflected on the harvested material. The radar sensor is arranged on a support device and is in particular carried by the support device. The support device is here movably mounted on the utility vehicle (for example, on its frame or chassis) in such a way that it can be set between a transporting position for the radar sensor and a working position for the radar sensor which is lowered relative to the transporting position.

The support device which is movably mounted on the utility vehicle enables fundamentally different positions of the radar sensor with respect to the utility vehicle, in particular the transporting position and the working position. The radar sensor can consequently be adapted to different operating modes. For example, the transporting position elevated relative to the working position can be used to protect the radar sensor from dirt and any damage in an improved fashion during a (transporting) drive outside the storage location of the harvested material without any additional measures. In contrast, the lowered working position can advantageously be used, when the utility vehicle is driving over the harvested material to compact it, to minimize the distance between the radar sensor and the harvested material and consequently to assist accurate density ascertainment with a small amount of radar energy.

At least one further position of the support device can preferably also be set between the transporting position and the working position, which is advantageous for the positioning and functionality of the radar sensor. In a movement direction of the support device, at least one further position of the support device can also be set beyond the transporting position or working position.

In a preferred embodiment, the movement of the support device can be controlled by means of an actuator. The actuator is here in particular a constituent part of the support device. The actuator can obtain different positions of the support device by means of its movements.

The actuator is preferably designed as a length-adjustable lever arm which is mounted, in particular movably mounted, on the utility vehicle (for example, chassis, frame). Suitable activation (for example, hydraulically, pneumatically, or electrically) can implement the desired movability of the support device in a technically simple fashion.

In a further advantageous embodiment, the transporting position and/or the working position can be set depending on environmental data. The environmental data represent at least one feature of a current environment of the utility vehicle. The environmental data are preferably generated by a suitable sensor system (for example, environment monitoring). Automatic position adaptation of the support device, and likewise automatically the in each case most advantageous positioning of the radar sensor, can be affected in real time with the aid of evaluated environmental data. It can, for example, be detected by means of the environmental data that the utility vehicle has driven into a silo such that the radar sensor can be transferred automatically into the working position and into a working mode in order to start the density ascertainment. Similarly, the radar sensor can be transferred automatically into its transporting position when, for example, the utility vehicle drives out of the silo.

More preferably, the working position of the support device or the radar sensor can be set at different vertical working heights. Consequently, the distance between the radar sensor and the surface of the harvested material can be varied individually during the density ascertainment, for example depending on the condition of the surface of the harvested material or on the specific technology used with the radar sensor. The distance between the radar sensor and the surface of the harvested material can be zero, which corresponds to contact between the radar sensor and the surface of the harvested material. Alternatively, a constant distance >0 between the radar sensor and the surface of the harvested material is, for example, set when driving over the harvested material to compact it.

In a further alternative embodiment, the setting of working heights is omitted. The support device, in particular its actuator, can here be placed in a floating mode such that the radar sensor slides along the surface of the harvested material in a free-floating fashion.

The working height can advantageously be set depending on profile data which represent a surface profile of the stored harvested material. Processing of the profile data can assist an automatic system (for example, by means of a control unit) for individually modifying the working height.

The profile data are preferably generated by means of an environment sensor arranged on the utility vehicle. Activation or actuation of the support device is consequently assisted in real time depending on current environmental conditions.

In further preferred embodiments, the transporting position and/or the working position and/or the working height can be set by means of a control unit activating the support device. The control unit can, for example, evaluate the abovementioned environmental data and/or profile data and/or other data and activate the support device in real time to implement the most suitable position or a position predetermined according to the evaluated data.

In a further advantageous embodiment, the radar sensor is arranged in a sensor housing which is movably connected to the support device. In particular, the sensor housing is pivotably connected to the support device with a pivot axis running parallel to a wheel axis of the utility vehicle. As a result, the sensor housing and the radar sensor are also pitchable, which assists good control of the movement of the sensor housing in the event of contact with the surface of the harvested material. The sensor housing assists defined position settings of the radar sensor and preferably accommodates additional components such as, for example, necessary electronics and further sensors. For example, the radar sensor can be a constituent part of a sensor device having the sensor housing and which, in addition to the radar sensor, optionally includes a unit for controlling the temperature of the sensor device. At least one further sensor (for example, a temperature or optical sensor) can also be included in the sensor device.

The support device is more preferably connected to a contact unit for mechanical sliding contact with the surface of the harvested material. This construction can protect the support device and the radar sensor with a low degree of technical complexity from undesired signs of mechanical wear when the utility vehicle drives over the harvested material to compact it.

The contact unit is advantageously connected to the support device by it being connected to the sensor housing and fastened thereon, in particular immovably fastened thereon. This arrangement enables physically effective and efficient use of the contact unit.

In a further advantageous embodiment, the contact unit has a runner-like cross section which preferably runs in the longitudinal direction of the utility vehicle. The runner-like cross section contributes to avoiding any malfunctions of the radar sensor because of an unfavorable surface profile of the harvested material.

In particular, a runner-like cross section is provided at two free ends of the contact unit which are situated opposite each other in the longitudinal direction such that the mechanical protection and/or physical sliding contact can be provided equally when the utility vehicle is driving both forward and in reverse during the compacting work or when driving over the harvested material to compact it.

A strain relief device mounted on the utility vehicle (for example movably and in particular in hinged fashion) is preferably provided which relieves the strain on the support device or at least components (for example, radar sensor, sensor housing, contact unit) connected thereto in terms of their weight force. The support device and/or the radar sensor and/or the sensor housing is here connected to the strain relief device in a suitable fashion, for example movably and in particular in a hinged fashion. As a result, the strain on the support device or at least the components connected thereto is relieved in terms of their weight force in such a way that these components cannot become buried in the harvested material when the surface of the harvested material is driven over. Already compacted layers of the harvested material thus remain reliably protected from any adverse impact on their already achieved state of compaction. Depending on the physical configuration of the strain relief device, quantitatively different strain relief, for example strain relief of 90% of the acting weight force, can be achieved.

The actuator mounted on the utility vehicle and controlling the movement of the support device is advantageously used for the weight force strain relief. The desired force strain relief can be implemented, for example, in the case of an actuator designed as a hydraulic cylinder by means of suitable pressure regulation and/or in combination with a suitably connected pressure-regulating valve or battery.

Alternatively or additionally, the strain relief device can have at least one spring element and/or at least one chain for the weight force strain relief. For example, a spring element, in particular a tension spring, is mounted on the utility vehicle and connected to one chain end of the chain, whilst the other chain end of this chain is connected to the support device and/or the radar sensor and/or the sensor housing in a suitable fashion (for example, movably). The strain relief device can also have a plurality of such spring/chain kinematic systems.

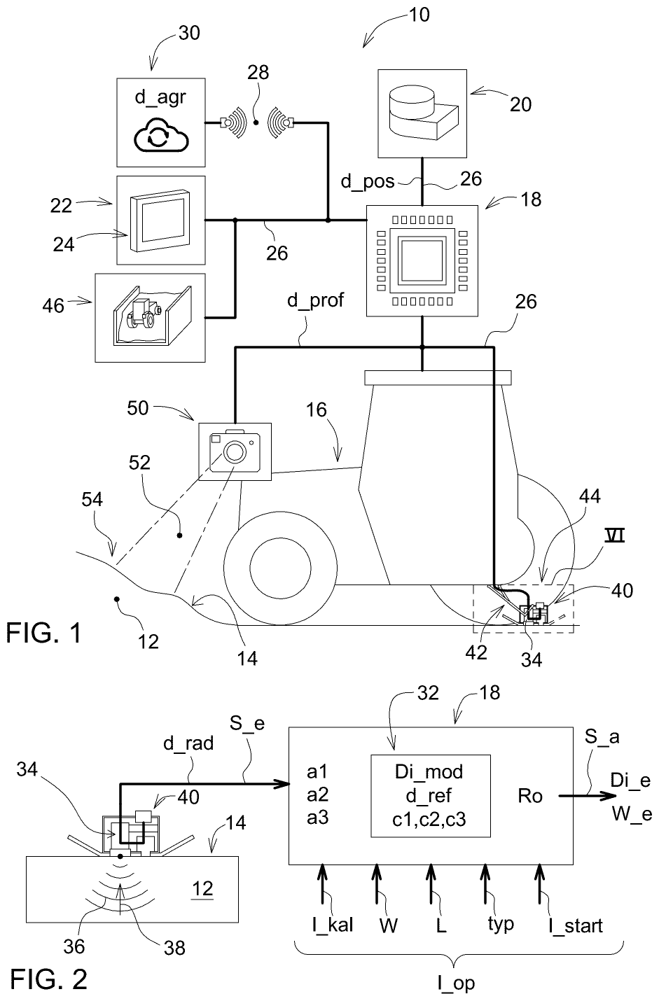

FIG. 1 shows a system 10 for ascertaining a density Di_e of a stored harvested material 12, the surface 14 of which is driven over by an agricultural utility vehicle 16, here in the form of a tractor, in order to compact it. The ascertained density Di_e is output by output signals S_a of a control unit 18. The output signals can optionally moreover include a moisture content W_e, ascertained by means of the control unit 18, of the harvested material 12 and further data of interest in relation to the compaction task.

The control unit 18 is preferably integrated in the utility vehicle 16. The utility vehicle 16 is controlled, for example, by a vehicle driver or is active in an automated manner as an autonomous vehicle.

The utility vehicle 16 and further components of the system 10 are connected to the control unit 18 via a suitable data connection in order to ascertain a current density Di_e and to communicate this to a worker (for example, the vehicle driver) in particular in a visual manner.

A position detection system 20 (for example, GPS) and a user interface 22 (for example, keyboard and display unit 24 for inputting and/or visually representing data) are arranged in or on the utility vehicle 16 and are in each case connected to the control unit 18 via a wired data connection 26. The control unit 18 is connected to a data center 30 via a wireless data connection 28. The data center can be based on cloud technology. It can serve as a central data storage device and/or data processing center for various agriculture-related activities of a farmer or on a farm. The data center 30 includes, inter alia, various agriculture-related data d_agr. At least some of these data d_agr can be generated, and stored in the data center 30, for example, while carrying out the method for ascertaining the density Di_e and/or they can be provided by the data center 30 before, and therefore also while, carrying out the method. For example, the control unit 18 sends various output signals S_a, in particular the current density Di_e, to the display unit 24 for visually representing the density Di_e in real time and simultaneously transmits these output signals S_a to the data center 30 via the data connection 28.

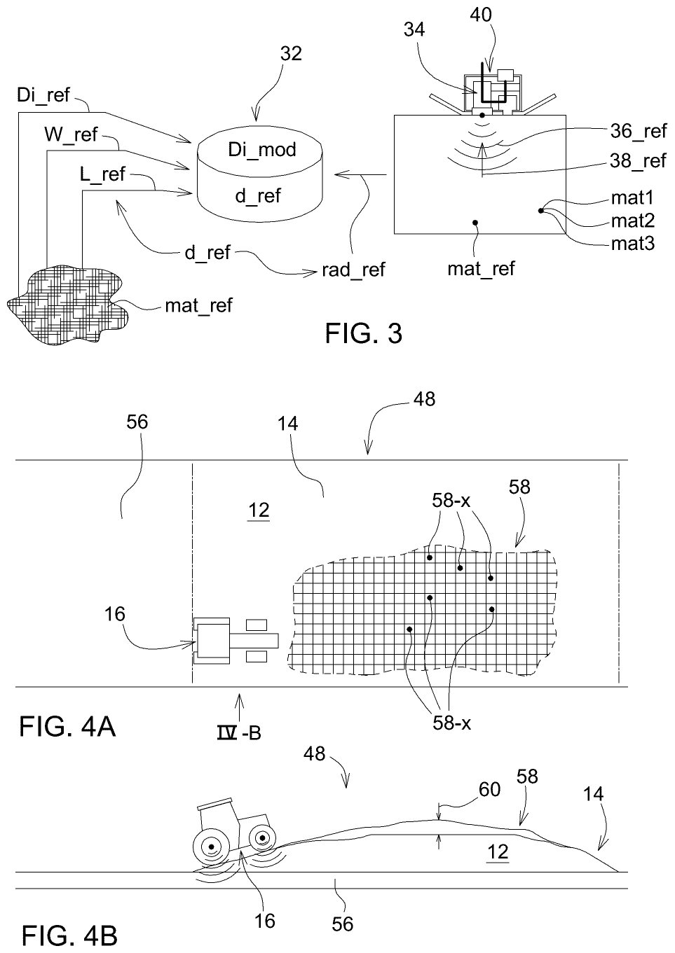

A database 32 with reference data d_ref and a density model Di_mod is included in the control unit 18 (FIG. 2). Alternatively, the reference data d_ref and/or the density model Di_mod or the database 32 can be present outside the control unit 18, in particular in the data center 30, such that the control unit 18 can at all times access the reference data d_ref and/or the density model Di_mod via the data connection 26 or 28. The reference data d_ref and the density model Di_mod are explained in more detail with reference to FIG. 3.

The control unit 18 ascertains a current density Di_e of the harvested material 12 by the use of radar technology. For this purpose, a radar sensor 34 which sends radar signals 36 in the direction of the harvested material 12 and receives radar signals 38 reflected on the harvested material 12 during the compacting task is arranged on the utility vehicle 16. The radar sensor 34 is a constituent part of a sensor device 40 which is arranged on a support device 42. The support device 42 is in turn movably mounted on the utility vehicle 16. The sensor device 40 and the support device 42 can be referred to jointly as a sensor module 44 which is explained in greater detail with reference to FIG. 6 to FIG. 7b.

The control unit 18 can access environmental data 46 of the storage location of the harvested material 12 in particular via the data connection 26. The storage location is in particular a silo 48 (FIG. 4a). The environmental data 46 are preferably generated by means of a suitable sensor system and saved in a database. They represent in particular current environmental conditions and features of the utility vehicle 16 in real time. With the aid of the environmental data 46, the control unit 18 can control the method for ascertaining the density, in particular automatically start the method for ascertaining the density, when the utility vehicle 16 has reached a corresponding position at the storage location.

Furthermore, an environment sensor 50, which generates profile data d_prof within a field of vision 52 on the basis of a detected surface profile 54 of the harvested material 12, can be arranged on the utility vehicle 16. The environment sensor 50 preferably also assists generation of the environmental data 46. The control unit 18 can activate the support device 42 depending on the profile data d_prof, as explained in greater detail with reference to FIG. 7a and FIG. 7b.

FIG. 2 shows the control unit 18 which receives, inter alia, radar data d_rad as input signals S_e. The radar data d_rad represent at least the radar signals 38 reflected on the harvested material 12 and possibly also further information. The reflected radar signals 38 can be processed with the supplied density model Di_mod on the basis of the radar data d_rad. Depending on the processing result, the current density Di_e can be ascertained or derived. The moisture content W_e of the harvested material 12 can optionally also be ascertained.

The density Di_e can be ascertained permanently currently or in real time by the control unit 18 when the utility vehicle 16 drives over the harvested material 12 to compact it. The control unit 18 can, however, also ascertain a current density Di_e whilst the utility vehicle 16 is stationary, in particular when it is stopped on the storage location or in the silo 48.

The control unit 18 can receive further information I_op or variables at least one additional signal input. These are, for example, an item of calibration information I_kal (for example, physical constants or material parameters with respect to the harvested material 12), a moisture content W of the harvested material 12, a cutting length L of the harvested material 12, a type typ of the harvested material 12 (for example, the type of crop, state of vegetation of the crop), an item of information I_start representing the start of the compaction (for example, a start signal for ascertaining the density Di_e, a start time for ascertaining the density, and a signal derived from the environmental data 46).

The abovementioned information I_op or variables can be retrieved from other data sources or they can be input manually via the user interface 22 or they can be provided by measurements (for example, by means of a sensor). Even more accurate ascertainment of the density Di_e can be assisted with this additional information I_op. The control unit 18 does not necessarily have to be provided with all of the abovementioned information or variables. For example, the moisture content W and the item of information type characterizing the harvested material 12 are information which is only optionally received by the control unit 18 in each case. Furthermore, other information or variables not mentioned here can also optionally be received by the control unit 18.

At least some of the information I_op is preferably generated when the utility vehicle 16 is driving over the harvested material to compact it, i.e., during the compacting work.

In a further function, the control unit 18 can be used to control the utility vehicle 16 depending on the ascertained current density Di_e in order to assist the operation of said utility vehicle. Thus, relevant vehicle parameters such as, for example, the tire pressure, the vehicle speed, or the steering, can be controlled by means of the control unit 18. Likewise, the control unit 18 can calculate a required remaining compaction depending on the ascertained current density Di_e. A material-specific target density (for example, depending on the type and moisture of the harvested material) can also be ascertained by the control unit 18.

FIG. 3 shows by way of example generation of reference data d_ref before the compacting of the harvested material 12 starts in the particular use case. In experimental trials for a reference material mat_ref of the harvested material 12, an item of reference radar information rad_ref is, for example, here detected on the basis of reflected reference radar signals 38_ref in the case of a defined reference density Di_ref, a defined reference moisture content W_ref, and a defined reference cutting length L_ref. The item of reference radar information rad_ref represents reflection behavior of the reference material mat_ref and possibly also further physical features. The item of reference radar information rad_ref can here take various compaction states (from 0% to 100%) into account.

When generating the reference data d_ref, a sensor device 40 is preferably used which is identical, at least in terms of the radar sensor 34, to the radar sensor 34 used when the utility vehicle 16 is driven over the harvested material to compact it. Emitted reference radar signals 36_ref here generate reflected reference signals 38_ref in the reference material mat_ref.

The reference data d_ref are preferably generated with respect to the same reference material for different states in terms of the reference density Di_ref and/or the reference moisture content W_ref and/or the reference cutting length L_ref. The reference data can also be generated for different reference materials mat_ref, in particular materials of different types of harvested material 12. Different reference materials are indicated by way of example in FIG. 3 by the materials mat1, mat2, mat3.

The data with respect to the reference density Di_ref can also include data which represent an expansion characteristic (in particular material behavior in the non-compacted state and after a defined compaction).

Depending on the reference data d_ref or at least some of this data, a density model Di_mod is derived or generated and can then be supplied for the method for ascertaining the density Di_e. The reference data d_ref are generated as calibration data and the density model can be considered as a defined result of a calibration method. In particular, the density model Di_mod includes or represents a mathematical or stochastic relationship between the item or items of radar information rad_ref and at least one of the abovementioned variables (reference density Di_ref, reference moisture content W_ref, reference cutting length L_ref). This relationship is such that accurate mathematical processing of the radar data d_rad with the density model Di_mod is assisted during the processing work in the particular use case.

For example, the density model Di_mod includes an algorithm or a formula according to which a model density Ro is defined as

Ro=c1·a1+c2·a2+c3·a3.

a1, a2, a3 are here place holders for amplitude values of the reflected radar signals 38 and c1, c2, c3 are derived from the reference data d_ref as coefficients. An amplitude spectrum, the amplitude values a1, a2, a3 of which are ascertained at predetermined characteristic frequencies, is calculated from the reflected radar signals 38. Defined amplitudes of the amplitude spectrum can thus be used as input variables for the density model Di_mod. In the example, the density Di_e to be ascertained is derived from the model density Ro, in particular is made to equal the model density Ro.

FIG. 4a and FIG. 4b show the silo 48 on the floor 56 of which the harvested material 12 is stored. Material 60 of the harvested material 12 is to be compacted in a surface region 58. With the aid of position data d_pos of the utility vehicle 16, the surface region 58 can be divided into multiple surface sections 58-x for which a density Di_e is ascertained in each case. The position-dependent density Di_e can then be sent to the user interface 22 by means of the control unit 18. The surface 14 to be driven over, in particular the surface region 58, can in this way be represented visually on the display unit 24 in real time, with current densities Di_e assigned section by section. Different densities Di_e can here be represented by different colors. For example, non-compacted surface sections 58-x can be represented by a red color, fully compacted surface sections 58-x can be represented by a green color and surface sections 58-x having other compaction states or levels can be represented by corresponding color gradations.

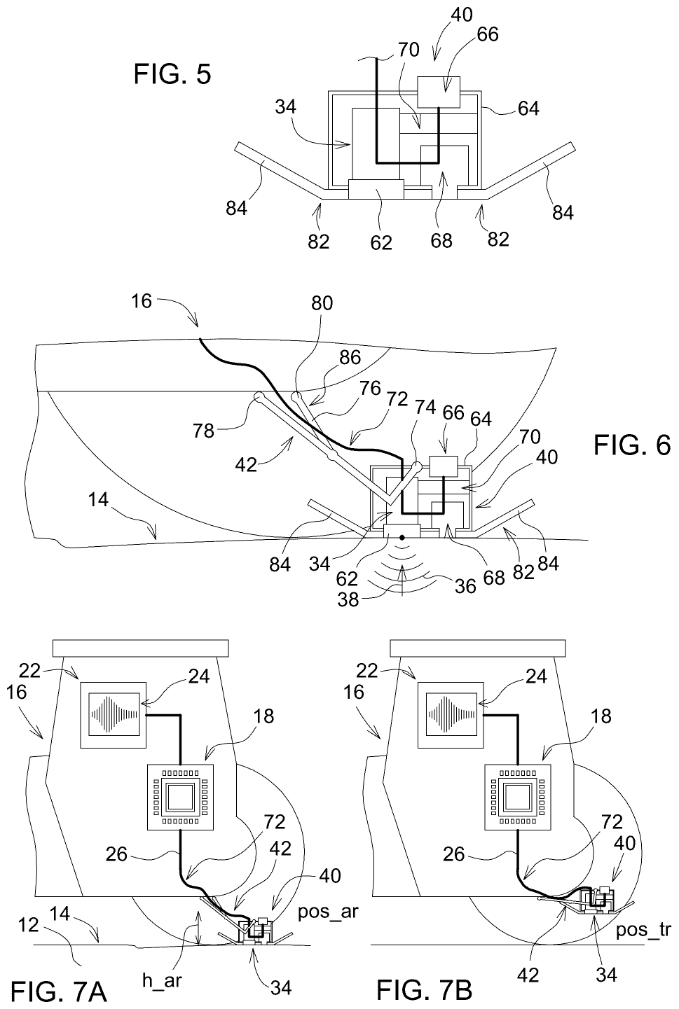

FIG. 5 shows the sensor device 40 with multiple components. The already mentioned radar sensor 34 is designed here as a radar antenna with a send and receive function. For efficient emitting of the radar signals 36 in the direction of the harvested material 12, the radar sensor 34 has a signal outlet 62 which traverses a sensor housing 64. Apart from the radar sensor 34, the sensor device 40 optionally includes a sensor unit 66 for controlling the temperature of the sensor device 40, and a further sensor system 68, for example for measuring the temperature or for optical detection in the region of the harvested material 12. An electronics system 70 for the radar sensor 34 and the optional sensors 66, 68 is moreover included in the sensor housing 64.

As can be seen in FIG. 6, the electronics system 70 is connected to a cable harness 72 for supplying energy to the sensor device 40 and for data transmission. The cable harness 72 preferably includes a supply cable for supplying energy to the sensor device 40 and a data cable for the data transmission. At least the data cable of the cable harness 72 is connected to the sensor device 40 and the control unit 18. Thus, for example, the reflected radar signals 38 can be sent to the control unit 18 in the form of radar data d_rad by means of the cable harness 72.

The sensor housing 64 is mounted movably on the support device 42, in particular is mounted on the support device 42 by means of a pivot axis 74 running transversely to the longitudinal direction of the utility vehicle 16. The support device 42 is designed as a multi-arm lever construction, the movement of which can be controlled by means of an actuator 76 in the form of a length-adjustable lever arm, for example a hydraulic cylinder. As a result, the actuator 76 effects the setting of different positions of the sensor device 40 relative to the surface 14 of the harvested material 12. Both the actuator 76 and the support device 42 are movably mounted on the utility vehicle 16 via the mounting points 78, 80.

The support device 42 is connected to a contact unit 82 for mechanical sliding contact with the surface 14 of the harvested material 12. The contact unit 82 is here fastened on a bottom side of the sensor housing 64 and assists the sensor device 40 or the radar sensor 34 in its functionality even in the case of an unfavorable profile of the surface 14 of the harvested material 12. The contact unit 82 has in each case one runner 84 at both longitudinal ends such that the function of the contact unit 82 is performed when the utility vehicle 10 is driving both forward and in reverse.

The positions of the support device 42 which can be set are in particular a working position pos_ar for the radar sensor 34 (FIG. 7a) and a transporting position pos_tr for the radar sensor 34 which is elevated compared with the working position pos_ar (FIG. 7b). The transporting position pos_tr is advantageously set when no ascertainment of the density is taking place, in particular when the utility vehicle 16 is situated outside the silo 48. The working position pos_ar which is lowered compared thereto is advantageously set when the utility vehicle 16 is driven into the silo 48 and in particular when it is standing on the harvested material 12. In order to set the two positions pos_tr, pos_ar, the support device 42 and/or the actuator 76 is activated by the control unit 18 depending on the environmental data 46.

The working position pos_ar can be set differently in terms of its vertical working height h_ar. As a result, direct contact (distance=0) or a constant distance >0 can, for example, be produced between the sensor device 40 or the contact unit 82 and the surface 14. For this purpose, the support device 42 and/or the actuator 76 is activated by the control unit 18 depending on the profile data d_prof. Alternatively, the support device 42 and/or the actuator 76 can be placed in a floating mode such that the sensor device 40 or the contact unit 82 slides along the surface 14 in a free-floating fashion. The dead weight of different components, in particular of the sensor device 40, can hereby advantageously be absorbed in such a way that these components do not become buried in already compacted material of the harvested material 12. This material thus remains reliably compacted. For this weight force strain relief, a strain relief device 86 mounted on the utility vehicle 16 is provided which includes, for example, the actuator 76. Alternatively or additionally, the strain relief device 86 can include other components (not illustrated here) for the force strain relief such as, for example, at least one spring element (in particular tension spring) and at least one chain. These components are preferably coupled to one another, mounted on one side on the utility vehicle 16 and connected to the sensor device 40 on the other side.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A utility vehicle for compacting a stored harvested material by driving over a surface of the harvested material, comprising a radar sensor configured for ascertaining a density of the stored harvested material by sending radar signals in a direction of the harvested material and receiving radar signals reflected on the harvested material, wherein the radar sensor is arranged on a support device which is movably mounted on the utility vehicle and can be set between a transporting position for the radar sensor and a working position for the radar sensor which is lowered relative to the transporting position.

2. The utility vehicle of claim 1, wherein a movement of the support device can be controlled by an actuator.

3. The utility vehicle of claim 2, wherein the actuator is designed as a length-adjustable lever arm which is mounted on the utility vehicle.

4. The utility vehicle of claim 1, wherein the transporting position or the working position can be set depending on environmental data which represents at least one feature of a current environment of the utility vehicle.

5. The utility vehicle of claim 1, wherein a vertical working height of the working position can be set differently.

6. The utility vehicle of claim 5, wherein the working height can be set depending on profile data which represents a surface profile of the stored harvested material.

7. The utility vehicle of claim 6, wherein the utility vehicle has an environment sensor configured for generating the profile data.

8. The utility vehicle of claim 1, wherein the transporting position, the working position, or the working height can be set by a control unit activating the support device.

9. The utility vehicle of claim 1, wherein the radar sensor is arranged in a sensor housing which is movably connected to the support device.

10. The utility vehicle of claim 1, wherein the support device is connected to a contact unit for sliding contact with the surface of the harvested material.

11. The utility vehicle of claim 10, wherein the contact unit is fastened on the sensor housing.

12. The utility vehicle of claim 10, wherein the contact unit has a runner-like cross section.

13. The utility vehicle of claim 1, wherein a strain relief device is mounted on the utility vehicle to relieve s strain on the radar sensor in terms of its weight force.

14. The utility vehicle of claim 13, wherein the actuator is a constituent part of the strain relief device.

15. The utility vehicle of claim 13, wherein the strain relief device has at least one spring element or at least one chain for the weight force strain relief.
